(19) United States
(12) Patent Application Publication
(10) Pub. No.: US 2012/0279311 A1
(43) Pub. Date: Nov. 8, 2012

(54) IMPACT DETECTION METHOD & APPARATUS

(76) Inventors: Richard James Neil Helmer, Victoria (AU); Allan Geoffrey Hahn, Australian Capital Territory (AU)

(21) Appl. No.: 13/504,801

(22) PCT Filed: Sep. 22, 2010
(86) PCT No.: PCT/AU2010/001239

§ 371 Date: Jul. 26, 2012

(30) Foreign Application Priority Data
Oct. 28, 2009 (AU) 2009905275

(51) Int. Cl. G01L 5/00

(52) U.S. Cl. 73/768; 324/71.1

(57) ABSTRACT

An impact detection apparatus (10), comprising: first and second electrical contacts (26a,26b; 30a,30b); and a detector (22) configured to detect bridging of the first and second contacts. The first and second electrical contacts (26a,26b; 30a,30b) are separated by a distance that is bridgeable by a predefined electrically conducting implement (16a; 16b), and the detector (22) is configured to detect the closing of a circuit upon any impact of the implement (16a; 16b) sufficient to bridge the first and second electrical contacts (26a,26b; 30a,30b) and to respond by outputting a signal indicative of the impact.

### RELATED APPLICATION

This application is based on and claims the benefit of the filing date of Australian application no. 2009905275 filed 28 Oct. 2009, the content of which as filed is incorporated herein by reference in its entirety.

### FIELD OF THE INVENTION

The present invention relates to an impact detection method and apparatus, of particular but by no means exclusive application in the detection of impacts in sports such as boxing and various martial arts.

### BACKGROUND OF THE INVENTION

Various systems have been proposed for detecting impact in sports such as boxing that employ accelerometers, piezoelectric sensors or motion sensors.

For example, U.S. Pat. No. 6,925,851 discloses a method and system for detecting and displaying the impact of a blow received on an item of athletic equipment. The system includes a plurality of items of athletic equipment, such as boxing gloves, each having a force sensor, logic and a wireless transmitter therein, a receiver adapted to receiver signals from each of the transmitters, and a processor for formatting the data for display. The logic identifies and stores signals exceeding a threshold for transmission.

U.S. Pat. No. 4,824,107 discloses a sports scoring device, including a piezoelectric transducer, for generating an analog output signal indicative of an impact to the transducer. The transducer may be mounted on protective equipment, such as a head guard, hand or footgear or protective vests, or can be mounted on training equipment, such as a heavy bag or striking pad.

U.S. Patent Application No. 20060047447 discloses a system for monitoring an athlete's performance during an athletic event, such as a boxing match or kick-boxing match, including a plurality of monitoring articles attached to each fighter and a computing device positioned outside the fighting environment. Each of the monitoring articles preferably includes a motion sensing device, a microprocessor and a wireless transceiver. Each monitoring article creates a real-time impact force signal for each punch or kick, which is wirelessly transmitted outside of the fighting environment to the computing device for processing into an impact value for transmission to and image on an electro-optical display.

U.S. Pat. No. 6,611,782 discloses a real-time boxing sports meter, wherein a power sensing unit is incorporated into a boxing glove for use according to a method of quantifying impact forces in a boxing match in real time. Impact force data is transmitted from the boxing glove to a remote receiver, and collated to assess the strike force generated by each boxer.

U.S. Pat. No. 5,723,786 discloses a boxing glove accelerometer provided in a boxing glove body to measure impact.

U.S. Pat. No. 5,978,972 discloses a helmet system including at least three accelerometers and mass memory for recording in real-time orthogonal acceleration data of a head. One embodiment includes at least three orthogonal accelerometers mounted within a sports helmet together with means for recording, in real-time, the data output from the accelerometers.

U.S. Pat. No. 7,128,692 discloses a system for providing quantitative assessment and relaying of fighter performance, using modified ergometer based technology, optical sensor and motion analysis technology, accelerometers, and hydraulic meters for the measuring or improvement of the performance of fighters, for the facilitating of recruiting efforts, or for the enhancement of boxing matches.

Other approaches are taught by U.S. Pat. Nos. 4,027,535 and 4,330,119. U.S. Pat. No. 4,027,535 discloses a manual thrust gauge comprising a frame having either a hand grip or a wrist strap, with a weighted member movably mounted to the frame and restrained by a spring which moves relative to a fixed member; one of these members comprises a scale and the other being a pointer and the movable member being releasably detained in any one of several displaced positions so that the user may thrust his hand as in a boxing punch, a karate chop or the like and the pointer will register on the scale the relative acceleration or deceleration of the punch. U.S. Pat. No. 4,330,119 discloses an inflatable striking member for being struck by the user in exercising or training, which yields a numerical, or other quantitative or qualitative indication, of factors relating to the striking factors, hopefully stimulating and encouraging the user to maximum attainments from the exercise or training. The device comprises an inflatable body member surrounding a conduit support member having a plurality of apertures therein, the apertures being in communication with the interior of the inflated member. A pressure/force responsive device is attached to the conduit such that a force applied to the inflatable member will be indicated by the pressure/force responsive device.

U.S. Pat. No. 4,208,048 discloses a punching bag with a power gauge, for use in developing boxing technique to indicate punching power during work-outs with practice equipment. The bag has a punch-receiving area with a pneumatic structure with connection through a releasable check-valve to a pressure gauge oriented for visibility by the person practising.

### SUMMARY OF THE INVENTION

According to a first broad aspect, therefore, there is provided an impact detection apparatus, comprising:
first and second electrical contacts; and
a detector (such as comprising an ammeter, a voltmeter, an ohmmeter or electronic circuitry) configured to detect bridging of said first and second contacts;
wherein said first and second electrical contacts are separated by a distance that is bridgeable by a predefined electrically conducting implement (such as a boxing glove or a police baton), and said detector is configured to detect the closing of a circuit upon any impact of said implement sufficient to bridge said first and second electrical contacts and to respond by outputting a signal indicative of said impact.

The apparatus may comprise a garment, such as a vest, or a head guard, such as a helmet.

Thus, in one embodiment a combination of electrical regions on, for example, two separate wearable items (such as textiles and garments such as vests, gloves and headguards) and appropriate electronic circuitry—such as in a wearable unit—is used to detect impacts in defined areas of two or more garments. In such an embodiment, impact is detected when an electrically conductive region on one garment connects with an electrically active region on another garment such that this impact contact leads to the completion of an electrical circuit on one or more of the garments, resulting in contact detection in the electronic circuitry. Typically the two contacting items are being worn by different people. The use of defined areas for contact and electrical connection across two separate garments has the advantage of enabling the discrimination of key scoring events in specified regions of the body, such as those used to score in amateur boxing (viz. the upper torso and head).

The present invention thus permits a more objective scoring in, for example, boxing. However, it is envisaged that it may be used advantageously in other activities, including other contact sports, various non-contact sports (for monitoring illegal contacts), training activities (such as in hand-to-hand combat or in the use of police batons) and activities where projectiles strike the body (such as ‘paintball’).

The apparatus may comprise a web affixable or fastenable to a garment.

In one embodiment, the first and second electrical contacts comprise first and second elongate members.

In a particular embodiment, the first and second electrical contacts comprise first and second wires, and may be interlaced.

The apparatus may comprise a resilient region (such as an elastic region). In such an embodiment, the resilient region may include the first and second electrical contacts.

The apparatus may comprise a hydrophobic region (which may comprise some or all of the apparatus). In such an embodiment, the hydrophobic region may include the first and second electrical contacts.

The hydrophobic region may, for example, be created by application of a stain resistant or hydrophobic composition (such as one of the Oleophobol (trade mark) range of compositions).

In a particular embodiment, the first and second electrical contacts are formed using textile processing. For example, this may be done with a circular knitting machine, such as a 28 gauge (needle per inch) 30 inch diameter 48 feed Jumberca Mini Jacquard double knit machine model 4TJ, and a mixture of non-electrically conductive and electrically conductive yarns (such as polyester and silver coated nylon yarn respectively) knitted into a two layer structure, with the electrically conductive yarns provided as alternating stripes on one side thereby providing the first and second electrical contacts.

The first and second electrical contacts may be in any suitable form including but by no means limited to: foils, wires, fibres or a flexible substrate on which a metal has been applied (such as, in the last case, a substrate coated with a metal by conventional spraying, direct contact, printing, or other vapour or chemical deposition technique).

In one particular embodiment, the first and second electrical contacts comprise nylon thread with a silver coating, or silver coated nylon yarn such as Shieldex (trade mark) 125/17 (2 ply).

In one embodiment, the apparatus comprises an electrical power supply (comprising, for example, one or more batteries), wherein the first and second electrical contacts are electrically coupled to the power supply, the first electrical contact, the second electrical contact and the power supply constitute an open circuit, and the detector is configured to detect the closing of the circuit upon any impact of the implement sufficient to bridge said first and second electrical contacts.

The power supply may comprise one or more batteries.

In certain embodiments, the detector comprises an ammeter, a voltmeter or electronic circuitry.

In a particular embodiment, the detector comprises an ohmmeter and the detector is configured to determine an occurrence of the impact from a drop in resistance between the first and second electrical contacts.

The implement may have an electrically conductive material or coating for bridging the first and second contacts.

The implement may have an electrically conductive region.

In a certain embodiment, the apparatus has a first impact detection zone comprising the first and second contacts, and the apparatus includes one or more additional impact detection zones provided with further respective pairs of electrical contacts.

The apparatus may further comprise one or more sensors. The one or more sensors may be selected from the group consisting of: an accelerometer, an electroencephalogram and a force sensor (such as a piezoelectric sensor).

The signal output by the detector may be indicative of a force of the impact (such as by indicating a minimum value in resistance between the contacts during the impact).

According to a second broad aspect, the invention provides an impact detection apparatus, comprising:
first and second electrical contacts comprising interlaced elongate members with respective electrical connectors for electrically coupling said first and second electrical contacts to a detector;
wherein said first and second electrical contacts are separated by a distance that is bridgeable by a predefined electrically conducting implement so that said detector can detect a bridging of said first and second electrical contacts by said implement.

The apparatus may comprise a garment, such as a vest, or a head guard, such as a helmet.

The apparatus may comprise a web affixable or fastenable to a garment.

In one embodiment, the first and second electrical contacts comprise first and second elongate members.

In a particular embodiment, the first and second electrical contacts comprise first and second wires, and may be interlaced.

The apparatus may comprise a resilient region. In such an embodiment, the resilient region may include the first and second electrical contacts.

The apparatus may comprise a hydrophobic region. In such an embodiment, the hydrophobic region may include the first and second electrical contacts.

In a particular embodiment, the first and second electrical contacts are formed using textile processing.

According to a third broad aspect, the invention provides an impact detection system, comprising:
an apparatus as described above;
a predefined electrically conducting implement adapted to close the circuit by bridging the first and second electrical contacts upon impact therewith; and
a communication mechanism for communicating the output signal from the detector to an impact monitor;
wherein the impact monitor is configured to record or display a record of the impact.

The implement may have an electrically conductive material or coating for bridging the first and second contacts.

The communication mechanism may be a wireless communication system, such as system utilizing the Bluetooth (trade mark) wireless protocol.

It should also be understood that the various features of each of the above aspects may be combined with each other and with the other aspects and features as desired.

### BRIEF DESCRIPTION OF THE DRAWING

In order that the invention may be more clearly ascertained, embodiments will now be described, by way of example, with reference to the accompanying drawing, in which:

FIG. 1 is a schematic view of a wearable impact detection system according to an embodiment of the present invention;

FIG. 2 is a schematic circuit diagram of several principal components of system of FIG. 1;

FIG. 3 is a schematic view of the processing controller and user interface of the computer of the system of FIG. 1;

FIG. 4 is a schematic view of the memory of the computer of the system of FIG. 1;

FIG. 5 is a schematic view of a wearable impact detection system according to another embodiment of the present invention;

FIG. 6 is a plot of impact data collected with the system of FIG. 1 under various test conditions; and

FIG. 7 is schematic view of a modified conductive region of a glove of the system of FIG. 1.

### DETAILED DESCRIPTION

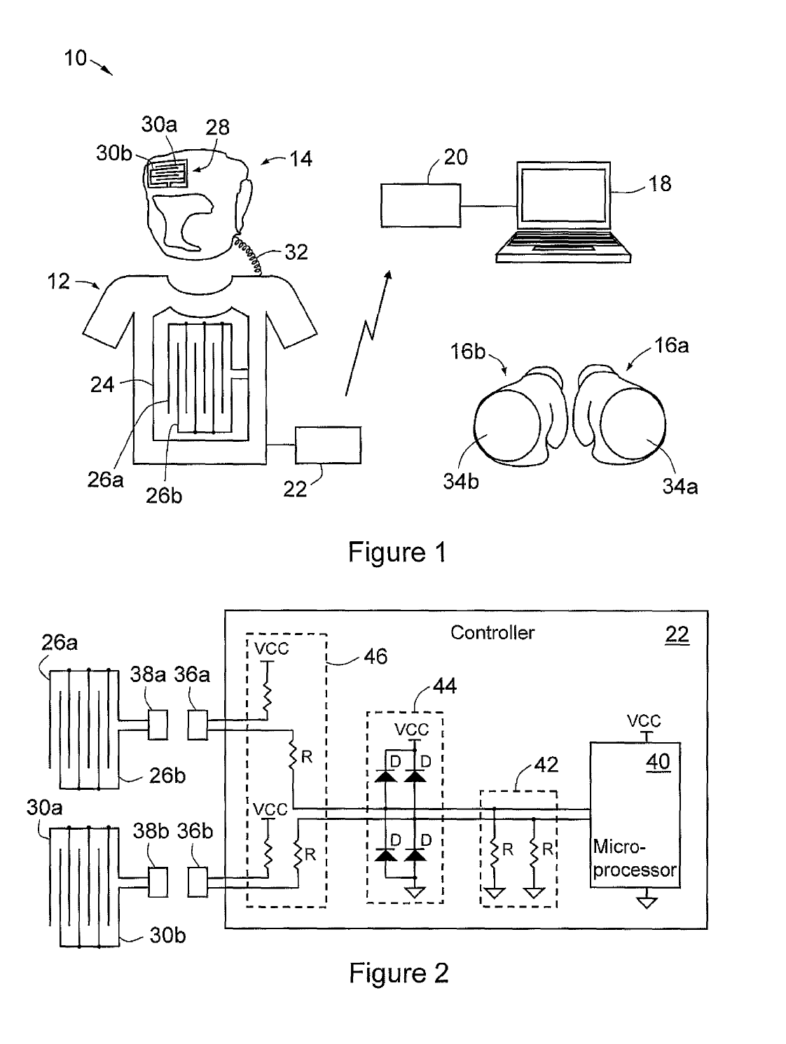

A wearable impact detection system according to an embodiment of the present invention is shown generally at 10 in FIG. 1. System 10 is adapted for use in the sport of boxing, and includes a vest 12 and a protective head guard 14 (to be worn by a first boxer), and a pair of boxing gloves 16a, 16b (to be worn by a second boxer). System 10 also includes a personal computer in the form of a laptop computer 18, a wireless router coupled to computer 18, in the form of Bluetooth hub 20, and a controller 22 that is electrically coupled to vest 12 and head guard 14, and in wireless communication by Bluetooth protocol with Bluetooth hub 20.

It should be noted that, although system 10 includes a single vest 12, a single head guard 14 and a single pair of boxing gloves 16a, 16b, other embodiments also include a second vest and a second head guard (to be worn by the second boxer) a second pair of boxing gloves (to be worn by the first boxer), and a second controller in wireless communication by Bluetooth protocol with Bluetooth hub 20.

Vest 12 has a first impact detection zone 24 occupying most of the front of vest 12 and, in use, over the chest of the first boxer. Impact detection zone 24 comprises a separately manufactured piece of fabric into which is woven an interlaced but spaced apart pair of electrical wires 26a, 26b (termed “first and second wires 26a, 26b” below).

First impact detection zone 24 is treated with a hydrophobic agent to repel moisture (from perspiration, water, etc), lest substantial shorting occur. Optionally, suitable composed hydrophilic regions may be created to draw any moisture away from electrical wires 26a, 26b, and to facilitate evaporative cooling. Impact detection zone 24 comprises a separately manufactured piece of fabric so that rest of vest 12 (essentially comprising a conventional vest or shirt) can be manufactured of an electrically insulating material to act as an electrical barrier between first impact detection zone 24 and the first boxer.

First and second wires 26a, 26b are electrically connected to controller 22, as is described in greater detail below. Similarly, head guard 14 is provided with a second impact detection zone 28 (located, in use, over the forehead of the first boxer and also treated with a hydrophobic agent) provided with its own respective pair of electrical contacts in the form of interlaced, spaced part electrical wires 30a, 30b (termed “third and fourth wires 30a, 30b” below). Third and fourth wires 30a, 30b are also electrically connected to controller 22 (as described below), via a connector cable 32. (In one variation of this embodiment, system 10 includes a second controller—comparable to controller 22—to which third and fourth wires 30a, 30b are connected, and which communicates wirelessly with Bluetooth hub 20; connector cable 32 is not required.)

Each of gloves 16a, 16b has a generally circular conductive region 34a, 34b, respectively. Conductive regions 34a, 34b may comprise coatings or adhered conductive patches. Possible coatings include a silver coated copper screening compound (RS 247-4251) or a nickel screening compound (e.g. electrolube, NSC 4008), applied to gloves 16a, 16b using a mask to control the shape and extent of regions 34a, 34b. Possible conductive patches include patches of a plain weave woven fabric formed with Shieldex silver plated nylon yarn (e.g. 125/17 2-ply), adhered to gloves 16a, 16b with—for example—a 3M (trade mark) spray adhesive, patches of aluminium foil or patches of aluminium coated polyester film, chosen according to application and desired wear characteristics.

The textile components of system 10 can be formed from separate layers and these may be integral and reusable or disposable so that they can be removed from vest 12, gloves 16a, 16b or head guard 14 and replaced as desired. This can be advantageous for items that suffer from significant wear, or where the basic item is otherwise not electrically conductive and requires a simple cheap modification (such as forming gloves 16a, 16b from conventional boxing gloves by the addition of conductive patches).

The basic operating principals of system 10 are as follows. When the second boxer lands a punch on the first boxer in either first or second impact detection zone 24, 28, the respective conductive region 34a, 34b bridges either first and second electrical wires 26a, 26b of vest 12 or third and fourth electrical wires 30a, 30b of head guard 14. Controller 22 is configured to act as a detector of such a bridging, such as by detecting a change in current through one or more of electrical wires 26a, 26b, 30a, 30b, a change in voltage across a respective pair of electrical wires 26a, 26b or 30a, 30b, or a change in resistance (or equivalently conductivity) between a respective pair of electrical wires 26a, 26b or 30a, 30b. In this embodiment, controller 22 acts as an ohmmeter, and—in response to an event—outputs an 8 bit signal indicative of the value of the resistance between, respectively, first and second electrical wires 26a, 26b and third and fourth electrical wires 30a, 30b to computer 18 via Bluetooth hub 20.

FIG. 2 is a schematic circuit diagram of several principal components of system 10 of FIG. 1, including first, second, third and fourth electrical wires 26a, 26b, 30a, 30b and controller 22. Controller 22 has a pair of 2-pin connectors 36a, 36b for coupling, in use, to a complementary pair of 2-pin connectors 38a, 38b connected to, respectively, first and second electrical wires 26a, 26b and third and fourth electrical wires 30a, 30b. These connectors 36a, 36b, 38a, 38b thus couple the electrical wires 26a, 26b, 30a, 30b to controller 22.

Controller 22 includes a microprocessor 40 and, between microprocessor 40 and connectors 36a, 36b, respective pull-down resistors 42, a line protection circuit 44 and respective current limiters 46. Controller 22 also includes a power supply comprising one or more batteries (not shown, but represented in the figure as “VCC”).

As described above, controller 22 acts as an ohmmeter; this functionality is provided by electronic circuitry in microprocessor 40. Pull-down resistors 42, in this embodiment, are used to limit the current to no more than 10 μA, principally to reduce power usage, the risk of electrical shock, and the corrosion of electrodes. The resistors are selected to match power supply VCC. Microprocessor 40 can be of essentially type of microprocessor or microcontroller with analogue input (so that signal conditioning is not required).

Controller 22 also includes a wireless communication system (not shown) employing the Bluetooth protocol, though it will be appreciated that other wireless communication systems would be acceptable, according to application, required bandwidth and the number of controllers (cf. embodiments in which each of a plurality of boxers or other users has a controller).

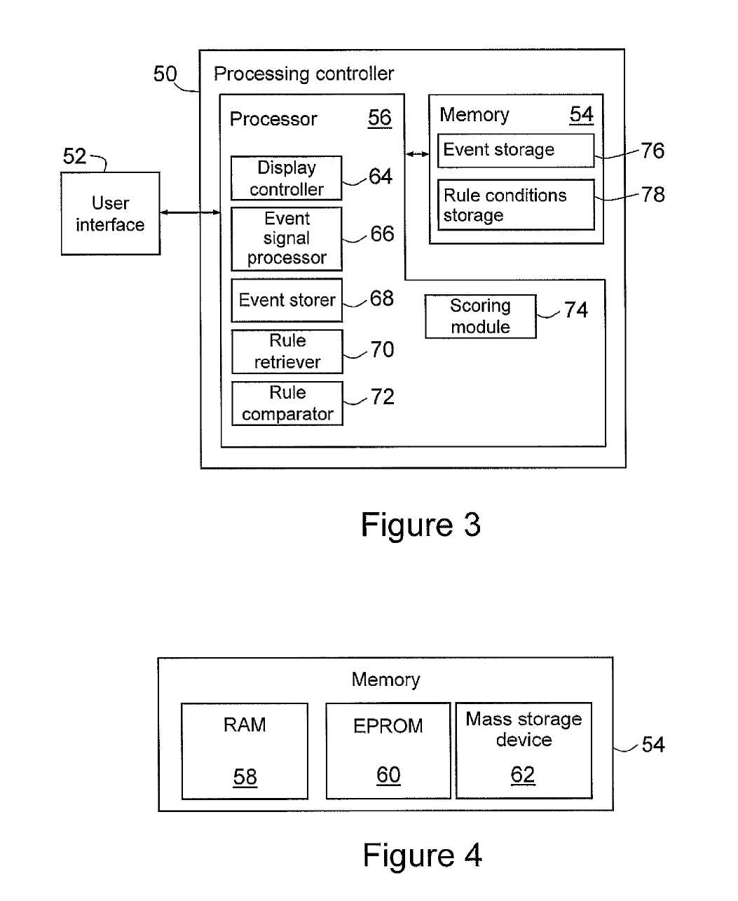

Computer 18 includes a processing controller and a user interface, shown schematically at 50 and 52 respectively in FIG. 3. Processing controller 50 includes a memory 54 and a digital processor 56. Processing controller 50 is in data communication with user interface 52 (comprising a keyboard, a computer mouse and a display), and is configured to process event signals received from controller 22 according to a processing procedure (stored as processing instructions in memory 54, as discussed below) and to output processing outcomes (which may comprise impact detection results or outputs formed by processing those results) to user interface 52. Processor 56 processes the processing instructions and output processing outcomes to user interface 52. The term “processor” is used to refer generically to any device that can process processing instructions and may comprise a microprocessor, microcontroller, programmable logic device or other computational device.

FIG. 4 is a schematic view of memory 54, which includes RAM 58, EPROM 60 and a mass storage device 62. RAM 58 typically temporarily holds program files for execution by processor 56 and related data. EPROM 60 may be a boot ROM device and/or may contain some system or processing related code. Mass storage device 62 is typically used for processing programs.

Referring to FIG. 3, processor 56 of processing controller 50 includes a display controller 64 for controlling the display of user interface 52, an event signal processor 66, an event storage manager 68, a rule retriever 70, a rule comparator 72 and a scoring module 74. Memory 54 of processing controller 50 includes an event storage 76 and a rule conditions storage 78 for storing rules defining various categories of impacts. Scoring module 74 determines a score from the output of rule comparator 72.

Event signal processor 66 and event storage manager 68 together provide logger functionality. Event signal processor 66 is passed event signals received from controller 22, discriminates between signals indicative or real and spurious events (rejecting the latter), extracts data transmitted in the signal associated with real events (including the measured resistance and hence force of the impact and whether the event arose from an impact on first impact detection zone 24 or on second impact detection zone 28), retrieves the time of receipt of the event (from a clock of computer 18) and passes the retrieved data and time to event storage manager 68. Event signal processor 66 discriminates between real and spurious events depending on the data contained in the signal. For example, a contact may be considered real (and hence a scoring event) if of suitable duration, such as between 10 and 1000 ms.

Event storage manager 68 stores the data and time as a new record in event storage 76. Rule retriever 70 is adapted to retrieve rules from rule conditions storage 78, and rule comparator 72 is adapted to compare impacts (retrieved from event storage 76 by event storage manager 68) with rules retrieved from rule conditions storage 78.

In a first mode of use, every impact to first or second impact detection zone 24, 28 is recorded by processing controller 50 as an event associated with a measured resistance value and a time in event storage 76. At the end of a bout, an operator controls computer 18 to stop collection; scoring module 74 determines a score based on a simple tally of the total number of events to user interface 52. In such a mode, rule comparator 72 need not be employed.

In a second mode of use, a number of points may be assigned to each impact, with more points awarded for an impact on one of first and second impact detection zones 24, 28. In this mode, rule comparator 72 compares each recorded event (collected as described above) with a rule in conditions storage 78 that specifies how many points should be awarded in each case, and passes the result to scoring module 74. Scoring module 74 then determines a score for output to user interface 52.

In other embodiments, system 10 includes one or more other sensors, such as one or more accelerometers (typically in gloves 16a, 16b or the forearm or wrist of the second boxer) to assist with impact discrimination, piezoelectric force sensors (on vest 12 or head guard 14), an electroencephalogram comprising heart rate monitoring electrodes (on vest 12). When these sensors are provided in gloves 16a, 16b, it is envisaged that the second boxer (i.e. the wearer of gloves 16a, 16b) will also have a vest and a head guard comparable to vest 12 and head guard 14, and a controller comparable to controller 22; sensors provided in gloves 16a, 16b will thus be coupled to that additional controller. Signals from all these sensors will be transmitted by controller 22 (or the additional controller) to Bluetooth hub 20.

The accelerometers are used in such embodiments to measure arm/wrist/fist acceleration, allowing the contact time of an impact (determined from the time for which first and second wires 26a, 26b are bridged or closed during an impact) can be used to assist in the discrimination of impact magnitude. For example, whilst the mass associated with the delivery of an impact by seconde boxer may not be easily determined, the contact time (derived from inter-garment connection) and velocity (derived from an accelerometer located on, for example, a forearm or wrist) of a punch can be combined to distinguish between hard and soft punches where relative impact impulse is proportional to velocity and time. Mathematical pattern recognition techniques can be applied to accelerometer signals to assist such categorisation.

Piezoelectric force sensors may advantageously be located in non-scoring or illegal zones of the first boxer, so that punches to those zones can be detected irrespective of the contacting part of the second boxer (e.g. a punch top the back, a knee to the groin or a headbutt to any part of the body of the first boxer).

Event signals generated by such additional sensors are processed and stored in by processing controller 50 in essentially the same manner as impact events detected by the bridging of first and second wires 26a, 26b or of third and fourth wires 30a, 30b. If system 10 includes such additional sensors, such as in competition where the application is more demanding and system 10 required to be more discerning in rejecting spurious events, event signal processor 66 discriminates between real and spurious events additionally using data derived from these additional sensors. For example, an impact in vest 12 of the first boxer (particularly of greater than average force) should coincide with a high acceleration reading from an accelerometer provided in, for example, gloves 16a, 16b. Thus, event signal processor 66 in such embodiments either rejects certain events as spurious (such as when an impact is not accompanied by a simultaneous or near simultaneous acceleration) or, if of the correct nature (e.g. an impact to vest 12 and acceleration of a glove 16a, 16b) and nearly simultaneous (to within a predefined window of, for example, 40 ms), associates and time stamps such events within a common wireless environment so as to ensure time synchronisation.

In such embodiments, multiple wireless controllers may be employed; each boxer, for example, may have as many as four or more transmitters. This may give rise to band limitations or network constraints, depending on the type of wireless communication that is employed. For example, the Bluetooth protocol supports one 1 master with 7 slaves, so plural ‘piconets’ may be required.

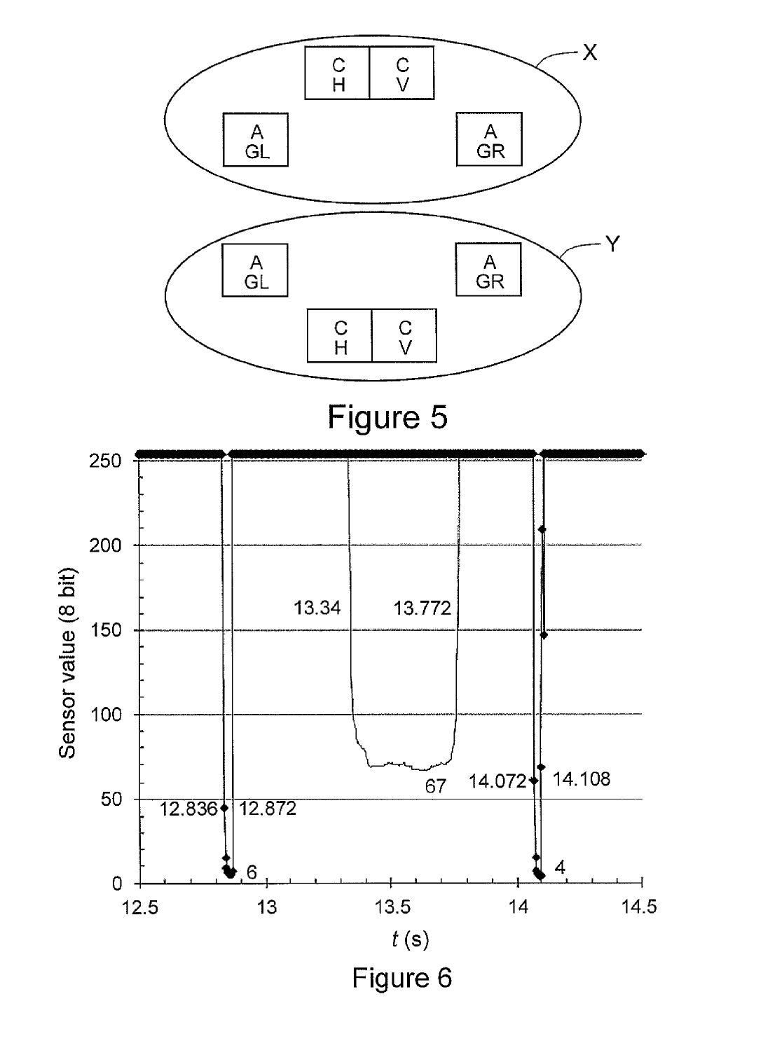

FIG. 5 is a schematic view of such an embodiment, to illustrate possible rules (as stored in rule conditions storage 78) for scoring. FIG. 5 represents the first boxer (X) and the second boxer (Y), each equipped with a vest (V) and a head guard (H) comparable to vest 12 and head guard 14, and each wearing left and right gloves (GL, GR) comparable to gloves 16a, 16b but equipped with accelerometers (A). Controller 22 includes firmware (not shown) that includes an analogue to digital converter for converting the analogue voltage detected across first and second wires 26a, 26b or third and fourth wires 30a, 30b to an eight bit digit such that, when a particular impact signal (S_{(XCV or XCH)}) from vest 12 or head guard 14 of first boxer X is greater than a certain value, i (e.g. i=0), and less than another value, I (e.g. I=15), and the impact duration, t_{c(XCV or XCH)}, is within a certain range (e.g. 15 to 150 ms), then a scoring event is sent to computer 18, which determines an updated cumulative score for second boxer Y and displays that updated cumulative score on its display. The update to the score may depend on whether the impact signal arose from an impact to vest 12 or to head guard 14.

Furthermore, the aforementioned rules can take account of digitised signals from other transducers, such as signals SYA_{GL,GR} from one or more accelerometers located on first and second boxers' gloves, to provide further event discrimination. For example, an impact signal (S_{(XCV or XCH)}) from the first boxer X could be deemed to be real (and not due to noise or some other artefact) if it corresponds, to within a certain specified time tolerance, with an accelerometer signal from the glove of second boxer Y, and that accelerometer signal falls within certain limits j and J (such as j=6 g and J=60 g, also to exclude bogus signals). For example, the contact of second boxer Y's left glove might result in a signal from an accelerometer provided therein that corresponds in time with a signal detected on the first boxer X's vest 12, which would allow computer 18 to confirm a left hit by second boxer Y to the body scoring region of first boxer X.

Such a set of rules may be summarised as follows:

| Rule Set | Score Second Boxer (Y) |
|---|---|
| 1 | X_{CV} or X_{CH} |
| | (i < S_{(XCV or XCH)} < I) |
| | (15 ms < t_{c(XCV or XCH)} < 150 ms) |
| 2 | (X_{CV} or X_{CH}) and (YB_{GL} or YB_{GR}) |
| | (i < S_{(ACV or ACH)} < I) |
| | (15 ms < t_{c(XCV or XCH)} < 150 ms) |
| | (j < SYA_{GL, GR} < J) |
| | t(XA_{CV} or XA_{CH}) ~ t(YA_{GL} or YA_{GR}) |

| Rule Set | Score First Boxer (X) |
|---|---|
| 1 | Y_{CV} or Y_{CH} |
| | (i < S_{(YCV or YCH)} < I) |
| | (15 ms < t_{c(YCV or YCH)} < 150 ms) |
| 2 | (Y_{CV} or Y_{CH}) and (XA_{GL} or XA_{GR}) |
| | (i < S_{(BCV or BCH)} < I) |
| | (15 ms < t_{c(YCV or YCH)} < 150 ms) |
| | (j < SXA_{GL, GR} < J) |
| | t(B_{CV} or B_{CH}) ~ t(A_{GL} or A_{GR}) |

### EXAMPLE

A vest 12 was formed from knitted materials such that it was elastic, so that the size and location of first impact detection zone 24 would be maintained relative to the size of the torso of the first boxer. This was to allow a standard sized vest 12 to be worn by boxers of different torso sizes, but nonetheless provide a first impact detection zone 24 that—in each case—would generally cover the chest of the boxer from level with the arm pits to the navel.

System 10, modified to include (as described above) piezoelectric force sensors, was then tested and functioned well in test mode; events were detected on gloves, vest and head guard. The analogue circuit of controller 22 (see FIG. 2) was configured such that, when first and second wires 26a, 26b were not bridged, the resistance was 100 kΩ with a nominal current of 33 μA; this state was assigned a digital value of 255, while shorting of this circuit was assigned a value of 0. A typical bridging impact from a circular conductive region 34a, 34b of gloves 16a, 16b respectively resulted in a contact value of S_{XCV}˜5.

FIG. 6 is a plot of sensor value (where 0 corresponds to 0 Ω and 255 corresponds to 10 kΩ) versus time t(s) collected from punches to vest 12 (with glove 16a) worn by a plastic torso, shown at 80a and 80b, and from the impact of an arm wrapped in a cloth soaked in 4% saline solution (to simulate a sweaty arm) to vest 12 worn by the plastic torso, shown at 82. The signals 80a, 80b, 82 are significantly different in signal amplitude and duration.

Tests with saline solution thrown onto vest 12 showed much of the water falling off vest 12 and more complex shaped low amplitude signals with extended duration. A test with the wet blanket underneath vest 12 failed to yield a signal. Punch impacts were typically 300 Ω for −50 ms whilst other sweat related events were >1000 Ω for >˜500 ms. Importantly, glove contact was found to produce a lower resistance (cf. FIG. 6) than the wetting events, permitting discrimination.

It appears, therefore, that it should be possible to measure the extent of perspiration of a boxer if system 10 is configured and calibrated appropriately.

On this basis, rules were established to filter out events arising from contacts with wet bodies (i.e. where S_{XCV}˜67) and to facilitate the reliable discrimination between punch contacts and push touches; these rules comprised setting i=0, I=15 and 15 ms<t_{c(YCV or YCH)}<150 ms.

A glove 16a, 16b was modified to alter the area of the glove's conductive region 34a, 34b; this was observed to significantly reduce self contact arising from blocking punches with defensive poses whilst scoring contacts were maintained at a high rate (indeed, with no observable change). This was achieved by reducing the area of conductive region of the scoring area of the glove in the lower finger region such that the conductive bar was thinner than the distance between any two contacts on vest 12 or head guard 14.

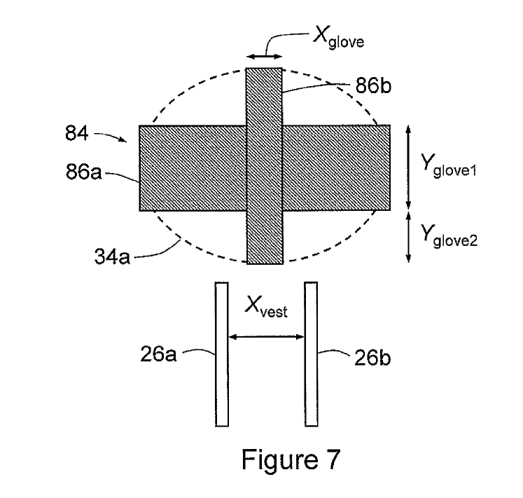

FIG. 7 is a schematic view of the modified conductive region 86 (shown with conductive region 34a for comparison, and with exemplary portions of first and second wires 26a, 26b). Modified conductive region 86 comprises a horizontal portion 86a (of height Yglove1) and a vertical portion 86b (of width Xglove). The width Xglove of vertical portion 86b is less than the nominal spacing Xvest of first and second wires 26a, 26b.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in Australia or any other country.

1. An impact detection apparatus, comprising:
first and second electrical contacts; and
a detector configured to detect bridging of said first and second contacts;
wherein said first and second electrical contacts are separated by a distance that is bridgeable by a predefined electrically conducting implement, and said detector is configured to detect the closing of a circuit upon any impact of said implement sufficient to bridge said first and second electrical contacts and to respond by outputting a signal indicative of said impact.

2. An apparatus as claimed in claim 1, comprising a vest or other garment.

3. (canceled)

4. An apparatus as claimed in claim 1, comprising a web affixable or fastenable to a garment.

5. An apparatus as claimed in claim 1, comprising a helmet or other head guard.

6. (canceled)

7. An apparatus as claimed in claim 1, wherein said first and second electrical contacts comprise: (i) first and second elongate members; (ii) first and second wires; or (iii) first and second elongate members that are interlaced.

8-9. (canceled)

10. An apparatus as claimed in claim 1, comprising a resilient region or a hydrophobic region.

11. An apparatus as claimed in claim 1, comprising a resilient region that includes the first and second electrical contacts.

12. (canceled)

13. An apparatus as claimed in claim 1, comprising a hydrophobic region that includes the first and second electrical contacts.

14. An apparatus as claimed in claim 1, comprising an electrical power supply, wherein said first and second electrical contacts are electrically coupled to said power supply, said first electrical contact, said second electrical contact and said power supply constitute an open circuit, and said detector is configured to detect the closing of said circuit upon any impact of said implement sufficient to bridge said first and second electrical contacts.

15. (canceled)

16. An apparatus as claimed in claim 1, wherein said detector comprises an ammeter, a voltmeter, electronic circuitry or an ohmmeter configured to determine an occurrence of said impact from a drop in resistance between said first and second electrical contacts.

17. (canceled)

18. An apparatus as claimed in claim 1, wherein said implement has an electrically conductive material or coating for bridging said first and second contacts, or an electrically conductive region.

19. (canceled)

20. An apparatus as claimed in claim 1, wherein said apparatus has a first impact detection zone comprising the first and second contacts, and said apparatus includes one or more additional impact detection zones provided with further respective pairs of electrical contacts.

21. An apparatus as claimed in claim 1, further comprising one or more of: an accelerometer, an electroencephalogram, a force sensor or another sensor.

22. (canceled)

23. An apparatus as claimed in claim 1, wherein said signal output by said detector is indicative of a force of said impact.

24. An impact detection apparatus, comprising:
first and second electrical contacts comprising interlaced elongate members with respective electrical connectors for electrically coupling said first and second electrical contacts to a detector;
wherein said first and second electrical contacts are separated by a distance that is bridgeable by a predefined electrically conducting implement so that said detector can detect a bridging of said first and second electrical contacts by said implement.

25. An apparatus as claimed in claim 24, comprising a garment or a head guard.

26. An apparatus as claimed in claim 24, wherein said apparatus comprises a web affixable or fastenable to a garment.

27. An apparatus as claimed in claim 24, wherein said first and second electrical contacts (i) comprise first and second elongate members; (ii) comprise first and second wires that are interlaced; or (iii) are formed using textile processing.

28. (canceled)

29. An apparatus as claimed in any one of claims 24, comprising a resilient region or a hydrophobic region.

30-31. (canceled)

32. An impact detection system, comprising:
an apparatus as claimed in claim 1;
a predefined electrically conducting implement adapted to close said circuit by bridging said first and second electrical contacts upon impact therewith; and
a wireless or other communication mechanism for communicating the output signal from the detector to an impact monitor;
wherein said impact monitor is configured to record or display a record of said impact.

33. An apparatus as claimed in claim 32, wherein said implement has an electrically conductive material or coating for bridging said first and second contacts.

34. (canceled)
